(19) United States
(12) Patent Application Publication
(10) Pub. No.: US 2021/0281648 A1
(43) Pub. Date: Sep. 9, 2021

(54) EXTRACTING AND PROPAGATING GEOLOCATION INFORMATION

(71) Applicant: Microsoft Technology Licensing, LLC, Redmond, WA (US)

(72) Inventors: Siddhartha ARORA, Redmond, WA (US); Vaibhav PARIKH, Redmond, WA (US); Ryan MA, Beijing (CN); Ovi DAN, Redmond, WA (US); Beibei CHENG, Redmond, WA (US)

(21) Appl. No.: 16/317,778

(22) PCT Filed: Jul. 14, 2016
(86) PCT No.: PCT/CN2016/089985

§ 371 Date: Jan. 14, 2019

(51) Int. Cl. H04L 29/08

(52) U.S. Cl. CPC H04L 67/18; H04L 67/22; H04L 67/02

(57) ABSTRACT

A geolocation extraction and propagation system for assigning a geolocation to a new user of a website is disclosed herein. An implementation of the geolocation extraction and propagation system assigns a geolocation to a website based on content of various web pages of the website as well as geolocations assigned to various users associated with the website. The geolocation extraction and propagation system further propagates the geolocation of the website to the new user by assigning the geolocation of the website to the new user in response to the new user's click on a web page of the website.

### BACKGROUND

Geolocation databases determine the location of online users based on their internet protocol (IP) address and/or their user profile. As an example, when a user searches for “weather” in a search engine on a computer, the search engine determines the geographical location of the user based either on their IP address or on information in their user profile. The search engine then displays the weather forecast for the geographical location as determined based on the IP address or the user profile. The search engine may use an IP geolocation database to determine the location of the user based on the IP address. However, the accuracy of the IP geolocation database varies based on location. Furthermore, use of the geolocation database is also quite expensive.

### SUMMARY

A geolocation extraction and propagation system for assigning a geolocation to a new user of a website is disclosed herein. An implementation of the geolocation extraction and propagation system assigns a geolocation to a website based on content of various web pages of the website as well as geolocations assigned to various users associated with the website. The geolocation extraction and propagation system further propagates the geolocation of the website to the new user by assigning the geolocation of the website to the new user in response to the new user's click on a web page of the website.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of a system for extracting and propagating geolocation information.

FIG. 2 illustrates example operations for propagating user locations through website clicks.

FIG. 3 illustrates example operations for propagating website locations through user clicks.

FIG. 4 illustrates example operations for extracting geolocations from web pages.

FIG. 5 illustrates example operations for determining geolocations of web pages based on clicks from users with known locations.

FIG. 6 illustrates example operations for determining geolocations based on queries in search engines.

FIG. 7 illustrates example operations for determining geolocations based on web hosting IP addresses.

FIG. 8 illustrates example operations for assigning geolocations to web pages based on geolocations of linked web pages.

FIG. 9 illustrates example operations for assigning geolocations to web pages based on geolocations of child pages.

FIG. 10 illustrates example operations for disambiguating between websites with local and global scope.

FIG. 11 illustrates example operations for disambiguating between multiple candidate geolocations.

FIG. 12 illustrates an example tree of locations used for disambiguating between multiple candidate geolocations.

FIG. 13 illustrates example operations for propagating locations based on user action.

FIG. 14 illustrates an example system that may be useful in implementing the described technology.

### DETAILED DESCRIPTIONS

Search engines often use the location of the user to customize the results shown on the page. For instance, for the query “weather,” the search engine uses the location of the user to display the weather forecast based on the location context of the user. One precise way to determine the location of a user is to use positioning systems such as geographic positioning system (GPS). Unfortunately, this information is not available for the majority of users, as the users would need to use a device with GPS and would also need to grant the search engine access to this information. Another method to determine the user's location is to ask the user to self-report it. While this might be accurate in the short-run, in the long-run the user might move to another location without updating the self-reported location. (Throughout this document the term geolocation refers to geolocation of either internet protocol (IP) address or a user's geolocation. The technology disclosed herein covers both cases of IP geolocation and user geolocation and therefore, the IP level geolocation and user level geolocation are used interchangeably. Similarly, throughout this document the terms “geolocation” and “location” are also used interchangeably).

In order to overcome the limitations above, the location of the user is determined by consulting an IP geolocation database. An IP geolocation database may contain ranges of IP addresses and their corresponding locations. When a user visits a search engine the geolocation database is used to determine their most likely geographical location. The granularity of the geolocation databases varies, but they may get down to the neighborhood or street level of granularity. However, the accuracy of such geolocation databases vary significantly based on geographic region. Furthermore, access to such geolocation databases may be costly.

The technology disclosed herein provides several methods to assign geolocations to user clicks. One method disclosed herein describes propagating the geographical information of users with known location to users or IP addresses with unknown location. This method is based on the premise that if many users with known location click on a certain website, a user with unknown location clicking on the same website may also be in the same location as the other users. Another method described here involves extracting geographical addresses mentioned in the text of website sub or child pages, and assigning the plurality location to the home page of the website. Subsequently, when a user with unknown location clicks on the home page of the website, such user is attributed the geolocation of the website.

Iii the context of this application, the terms “user click,” a “user's click,” “a user's clicking,” “a click by a user,” etc., with respect to a web site or a web page are meant to include a number of various actions by a user. For example, such actions include a user selecting the universal resource location (URL) of a website (in a browser, in an application, from a mobile app, etc.), the user submitting a query of the website in a search engine, the user being redirected to the website, a user actually clicking on content or links on a web page, etc. Thus, for example, if a user have saved the bookmark for www.seattle.com as “Seattle” on a browser and in response to the user's selecting that bookmark, the home page of www.seattle.com is loaded on the user's browser, the user is deemed to have clicked on the home page of www.seattle.com.

Similarly, if user submits a query and one of the query result is a link to www.seattle.com, the user's selecting this query result is deemed to user clicking on www.seattle.com in the context of the technology disclosed herein. Note that for a user to be considered to have clicked on a web page, the user does not need to perform any additional action. Thus, the user does not need to have reviewed the web page for any particular amount of time, the user does not need to have provided any information to the web page—either directly or indirectly via any cookies, the user does not need to have selected any content from the web page, activated any links on that web page, etc.

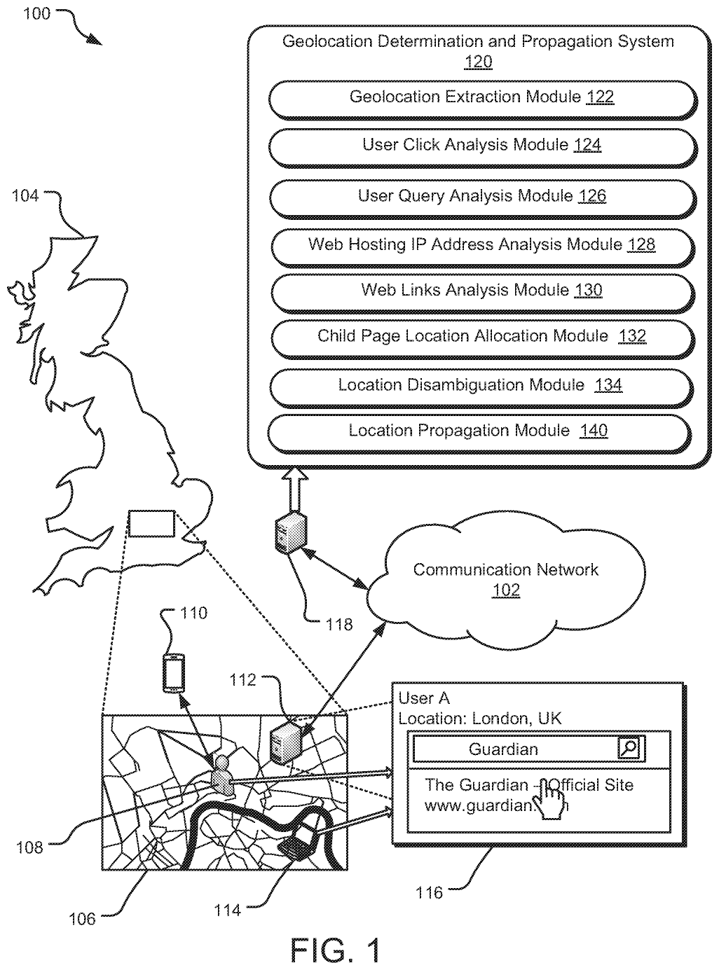

FIG. 1 illustrates an implementation of a system 100 for extracting and propagating geolocation information. Specifically, FIG. 1 illustrates a geolocation determination and propagation system 120 that may be implemented on a server 118. The server 118 may be communicatively connected to a communication network 102 such as the Internet. The geolocation determination and propagation system 120 allows assigning geolocations to various websites, such as a website 116 http://www.guardian.com/. In the illustrated implementation, the website 116 is hosted by a web hosting server 112 located in London metro area 106, which is located in United Kingdom 104. The website 116 may be visited by a first user 108, where the location of the first user 108 may be determined based on the GPS location of a mobile device 110 used by the user 108. A second user (not shown) may also access the website 116 using a computer 114.

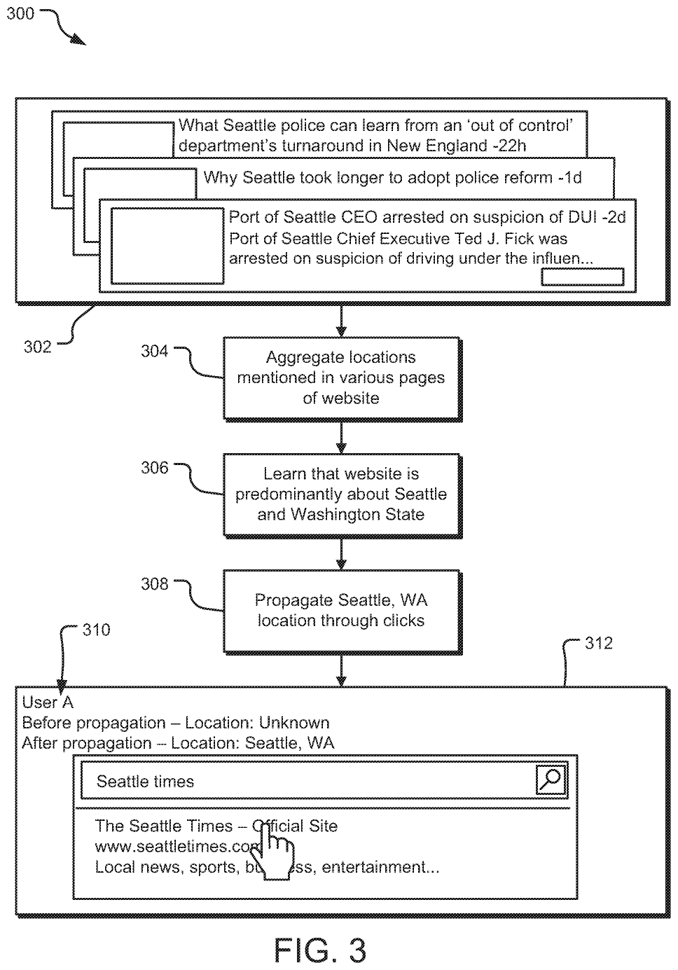

The geolocation determination and propagation system 120 includes various modules that may be implemented on the server 118 by various computer instructions. Various algorithms and operations of these modules are further described below with respect to FIGS. 3-13. For example, the geolocation determination and propagation system 120 includes a geolocation extraction module 122 that analyzes the content of one or more web pages of the website 116 to determine a geolocation of the website 116. For example, the geolocation extraction module 122 may find text strings such as Britain, Wembley, House of Lords, etc., that may be used to identify that the geolocation of the website 116 is London metro area 106. A user click analysis module 124 of the geolocation determination and propagation system 120 may analyze the clicks on the website 116, such as clicks by the user 108 whose location in the London metro area 106 is known based on the GPS parameters of the mobile device 110 used by the user 108. Thus, the user click analysis module 124 may assign the geolocation of the user 108 to the geolocation of the website 116. Note that this example assigns geolocation of only one user 108 to the geolocation of the website 116, in alternative implementation, geolocation of the website 116 may be assigned based on analysis of a large number of users who click on the website 116.

A user query analysis module 126 analyzes user queries and clicks on the results of such queries to determine the geolocation of the website 116. A web hosting IP address analysis module 128 determines that because the location of the web hosting server 112 is in the London metro area 106, it assigns the London metro area 106 as also the geolocation of the website 116.

A web links analysis module 130 analyzes one or more links from the various pages of the website 116 to other web pages (not shown) to determine the geolocation of the website 116. For example, if the web links analysis module 130 determines that a large number of incoming or outgoing links to the web pages of the website 116 also originate and terminate in the London metro area 106, it assign the London metro area 106 as the geolocation of the website 116.

A child page location allocation module 132 determines geolocation of various child web pages (not shown) of the website 116 to determine the geolocation of the website 116. For example, if a large number of child web pages of the website 116 include text strings that indicate that their geolocation is the London metro area 106, the child page location allocation module 132 also assigns the London metro area 106 as the geolocation of the website 116.

A location disambiguation module 134 disambiguates between various candidate geolocations for the website 116. For example, there are about 29 places in the world that are named London, including 15 in the United States. The location disambiguation module 134 generates various signals, such as high accuracy locations from the website 116 (such as London, UK), potential location candidates, population of each location named London in the world, distance between London and other potential location candidates, etc., to determine that the actual location of the website 116 is <London, UK, Europe, World>.

A location propagation module 140 propagates the geolocation of the website 116 to geolocation of the user that accesses the website 116 using the computer 114. Specifically, the location propagation module 140 analyzes various clicks from the computer 114 to the website 116 in view of clicks by other users (such as the user 108) with known location to determine that the geolocation of the website 116 may be assigned to the geolocation of the computer 114 and its user.

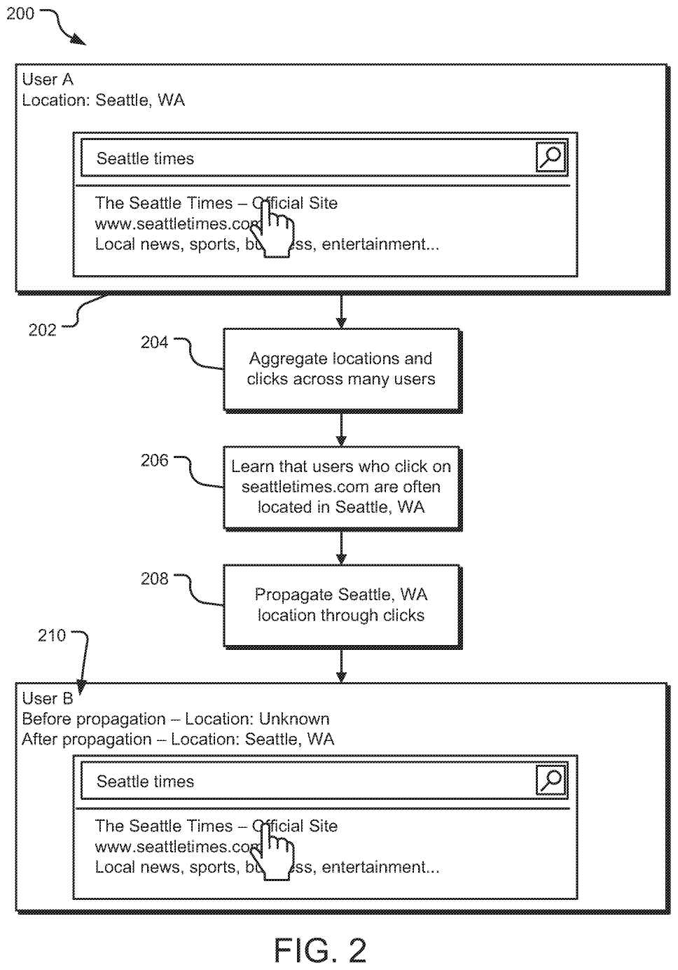

FIG. 2 illustrates operations 200 for propagating user locations through website clicks. Specifically, an operation 204 aggregates locations and clicks by a large number of users on a website 202 www.seattletimes.com. An operation 206 analyzes the user locations and clicks to determine that the users that click on www.seattletimes.com are often located in Seattle. An operation 208 propagates the geolocation of the website 202 to new users, such as user B 210 that clicks on the website 202.

FIG. 3 illustrates operations 300 for propagating website locations through user clicks. Specifically, an operation 304 aggregates locations that may be mentioned in various pages of a website 302. An operation 306 determines that the website 302 is predominantly about Seattle and Washington State based on analysis of the aggregated locations. An operation 308 also propagates the geolocation of the website 302 through user clicks. In other words the operation 308 analyzes various clicks on the website 302 by various users and determines such users may be from Seattle. Thus, when a user A 310 clicks on the website www.seattletimes.com 312, the geolocation of the user A 310 is determined to be Seattle.

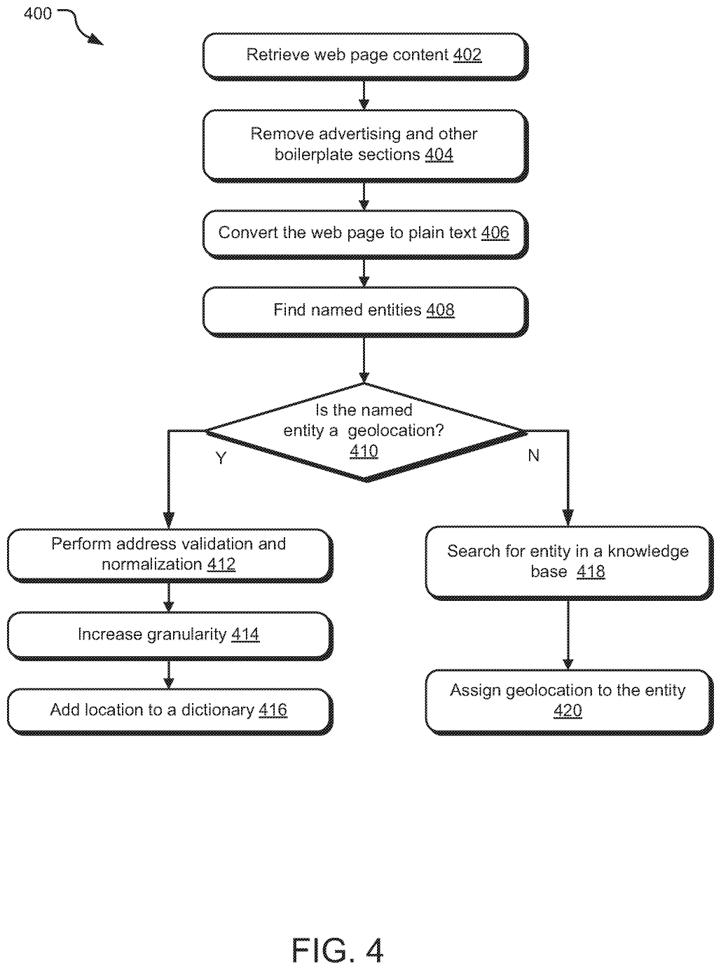

FIG. 4 illustrates operations 400 for extracting geolocations from web pages. Specifically, some web pages, such as news articles, often contain words indicative of geolocations. Thus, if a web page mentions a location, a click to the web page could indirectly indicate an affinity to the extracted location. The operations 400 provides for processing the information from such websites to extract such geolocations. An operation 402 retrieves the content of the web page from the Internet. For example, a crawler used by the geolocation extraction and propagation system disclosed herein may retrieve such web page content and store it in a database for further processing. In one implementation, an operation 404 removes advertising and other boilerplate sections such as copyright notices, etc., from the retrieved web page content. An operation 406 converts the web page content to plain text, or such other form where it can be analyzed to find named entities.

An operation 408 analyzes the plain text of the web page content to find one or more named entities from the web page content. For example, such named entities may be, names of places, people, organizations, landmarks, etc. For example, for a news website such as www.seattle.com, the operation 408 may analyze the content to find named entities such as “Bellevue,” “Redmond,” “Microsoft,” “Starbucks,” “Satya Nadella,” “Seahawks,” etc. Each of these entity strings may indicate that the given website is related to Seattle, Wash. An operation 410 determines if the named entity is a geolocation or something other than a geolocation, such as name of a person, organization, landmark, etc.

For each named entity that represents a geolocation, an operation 412 may perform address validation and normalization on the extracted location. For example, if the input is a string that contains an address, the output may be a validated and normalized address. As an example, for input: “450 108th Av Bellevue”, the output of the validation and normalization operation 410 may be “450 108TH AVE NE, BELLEVUE Wash. 98004-5506”. In one implementation, the operation 410 may input the input string to a database to find the validated and normalized output.

An operation 414 increases the granularity of the geolocation to a desired level. For example, if a city-level granularity is required, the operation 414 discards the street address and only keeps the city, state, and country from the validated and normalized string. An operation 416 adds the desired granular location to a dictionary where the key is the normalized address and the value is the number of times the string generating the normalized address is found in the website. Thus, if there are ten (10) strings that result in “Bellevue,” for the key “Bellevue,” the value is ten (10).

For each named entity from the website that represents an entity other than a location (such as names of organizations, people, landmark, etc.), an operation 418 searches for the entity in a knowledge base with a fixed ontology, which may organize various information into various categories. An ontology is a formal representation of a domain of knowledge. In other words, it is a schema that explains the relationship between types of objects and their attributes. A schema for a city may specify that every city should have a name, a mayor, a country, etc. The ontology does not contain the data itself, it just describes how the data should be structured. An example of such ontological database may have categorization of entities, products, locations, facts about the world, etc. For example, an entry in such a knowledge base may specify that “the headquarters of the company Microsoft are in Redmond, Wash.”

If the entity has been found in such knowledge database, an operation 420 assigns a geolocation to the entity. For example, some people, such as city mayors or governors, may be linked to geographical areas. For example, if an article mentions ay Inslee, who as of this writing is the Governor of Washington State, the operation 420 may infer that the article indirectly references the geographical area of Washington State. Similarly, organizations such as local restaurants may be linked to a particular geographical address. For instance, if a web page contains a restaurant review, the operation 420 may use the name of the restaurant in conjunction with the knowledge base to determine that the article indirectly references a particular address (the location of the restaurant). The operation 420 may also use this methodology for chain restaurants such as Starbucks, if the text mentions a particular location of the chain. Similarly, if landmarks (points of interest) such as “Space Needle” are mentioned in the text, the operation 420 may infer the location of the article by determining the address of the “Space Needle” landmark.

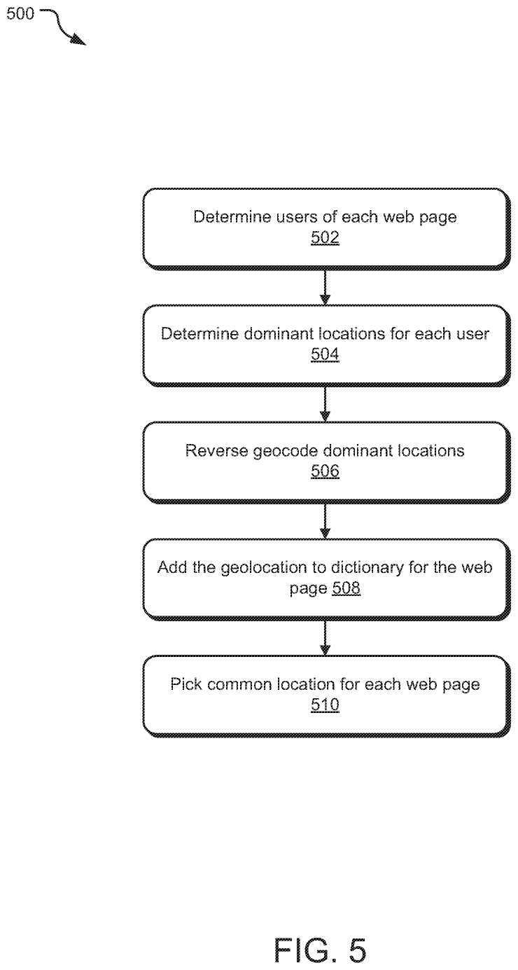

FIG. 5 illustrates operations 500 for determining geolocations of web pages based on clicks from users with known locations. The operation 500 is able to determine geolocations of web pages from clicks of users with known locations because users from a given location are more likely to click on web pages related to that location. For example, given that people from Seattle are more likely to click on www.seattletimes.com, if a new user with unknown location also clicks on www.seattletimes.com, then maybe such new user is also in Seattle. The operations 500 may use a database of users with known locations, as well as a click log of the web pages these users visited. A database of users with known locations can be obtained, for instance, from a search engine where a subset of users that have devices with GPS hardware grant permission to the search engine to collect real time GPS location data when users issue queries. The same online service can also collect a click log of all the websites the same users clicked on.

For each web page of a given website, an operation 502 determines various users that clicked at least once on that web page. Subsequently, for each of these various users that clicked on at least one web page, an operation 504 determines their dominant location by clustering all location readings for this user from the log. In one implementation, the operation 504 may discard outliers and pick the center of the largest cluster. An operation 506 reverses geocodes of the dominant location of the user. Specifically, the operation 506 takes the coordinates (latitude, longitude) of a geolocation reading and converts it into an address such as 123 Main St, City, State, Country. An operation 508 adds the geolocation for each user to a dictionary for the web page where the key is the normalized address, and the value is the number of times the strings or the entities that result in the normalized address are found on the web page. For each web page in the clicks log, an operation 510 picks a common location in the dictionary corresponding to this web page.

Alternatively, apart from geolocation extracted from devices with GPS hardware, geolocations can also be assigned to users by using information from their profile. For instance, if an online service requires users to provide an address when they register, this address may be used directly instead of the location inferred from GPS traces of the users.

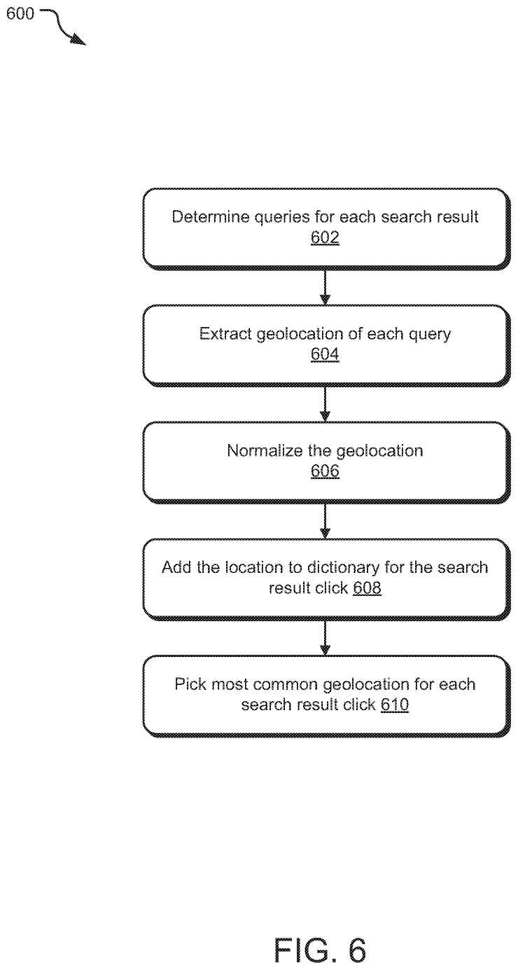

FIG. 6 illustrates operations 600 for determining geolocations based on queries in search engines. The operations 600 are able to determine geolocations based on queries in search engines because users from a given geolocation may search for a query that contains the name of that geolocation. For example, if many people from Seattle search for a query that contains Seattle, such as “Seattle news”, and then click on komonews.com, then komonews.com may be somehow related to Seattle. As a result, if a new user with an unknown location clicks on komonews.com, such new user may also be located in Seattle. The operations 600 use a search engine query log that contains the queries and search result clicks issued by a cohort of users.

For each click on a search result, as provided by the search engine query log, an operation 602 determines the query issued by the user before clicking on the search result. An operation 604 extracts the explicit geolocation from the query. For instance, for the query “weather in Kirkland”, the explicit location is “Kirkland”. If the extraction operation 604 is successful, an operation 606 normalizes the location. For example, the operation 606 may normalize “Kirkland” to “Kirkland, Wash. USA”. An operation 608 adds the normalized location to a dictionary for each click search result, where the key is the address mentioned in the query that lead to the user clicking this result, and the value is the number of times users have used this location in the query that leads to the click on this search result. For each query search result, an operation 610 picks the common location from the corresponding dictionary.

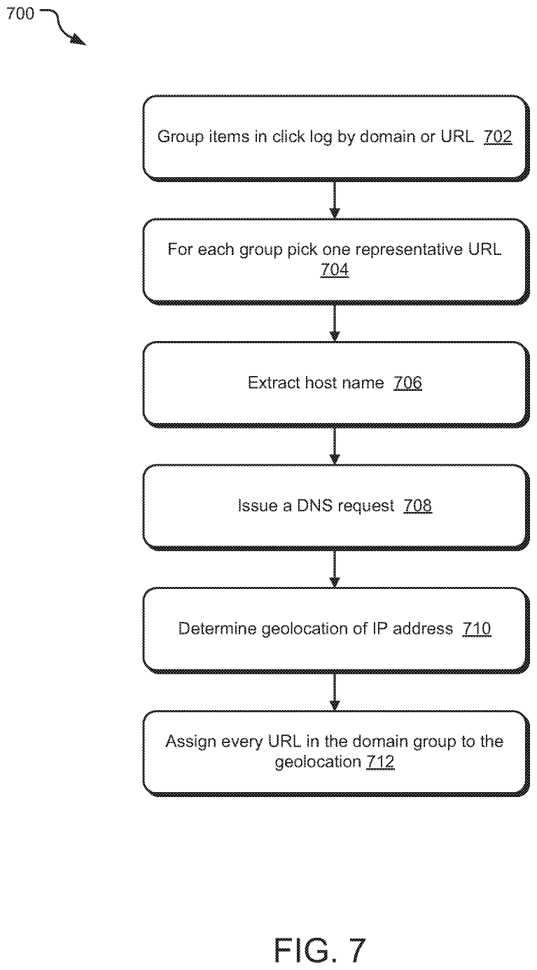

FIG. 7 illustrates operations 700 for determining geolocations based on web hosting IP addresses. The operations 700 are able to determine geolocations based on web hosting IP address because all pages in a website may be assigned a location given by an IP address of the server hosting the website. The operations 700 use an existing IP geolocation database and a click log. An IP geolocation database maps IP ranges to geolocations. Therefore, given a particular IP address, the database can be used to determine the likely geolocation of that IP address.

An operation 702 groups items in the click log by the domain of each universal resource locator (URL). For example, for a URL like http://www.seattletimes.com/seattle-news/, the operation 702 groups it into the seattletirnes.com domain. For each group, an operation 704 picks one representative URL from each domain group. In one implementation, the representative URL in a group may be the common URL in that group and any ties may be dealt with randomly. For example, for the seattletimes.com group, the representative URL may be http://www.seattletimes.com/. An operation 706 extracts the host name from the representative URL. In the example given here, http://www.seattletimes.com, the host name may be www.seattletimes.com.

An operation 708 issues a domain name service (DNS) request to determine the IP address of the host name. If needed, the operation 708 may follow canonical name (CNAME) record redirects until it finds an A record, where the A record maps a host name to one or more IP addresses. An operation 710 determines the geolocation of the IP address by consulting the geolocation database. If a geolocation is found, an operation 712 assigns the geolocation to various URLs in the domain group.

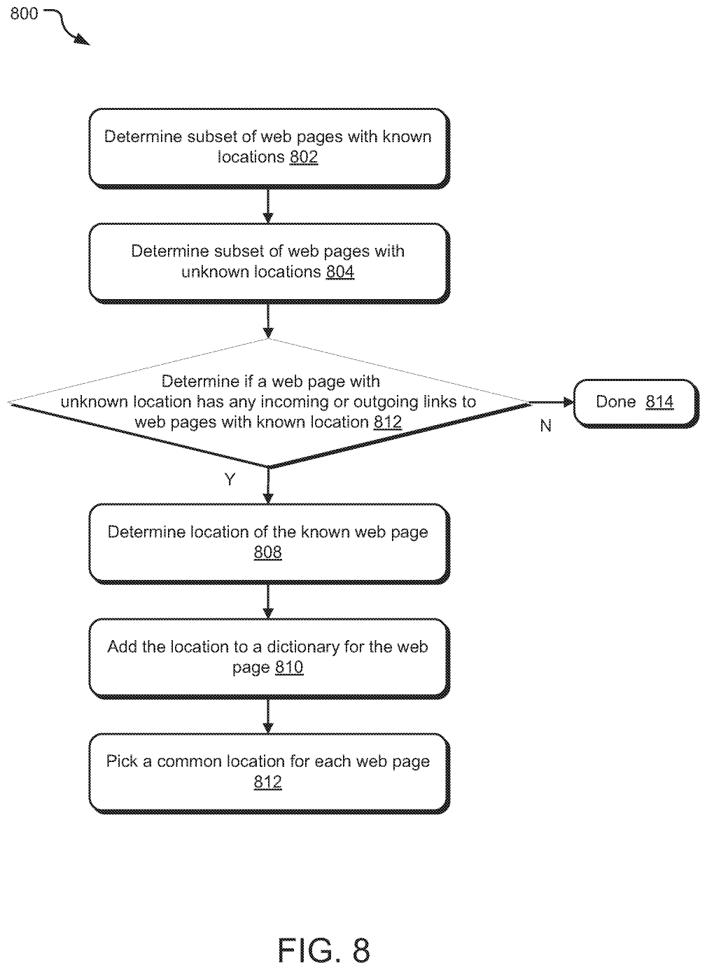

FIG. 8 illustrates operations 800 for assigning geolocations to web pages based on geolocations of linked web pages. Given that the web pages are interconnected by hyperlinks or links (either within the same website and/or to web pages of other websites), the link structure may be used to infer the location of web pages with unknown locations. The operations 800 use a representative subset of online web pages and the links between them to perform one or more of these operations. An operation 802 determines a subset of web pages with known location (subset A). For example, the operation 802 may determine the location of web pages using any of the multiple other methods disclosed herein. An operation 804 determines a subset of web pages with unknown locations (subset B).

For each web page in the subset B, an operation 806 determines if a web page with unknown location (subset B) has any link, whether incoming or outgoing, to a web page in the subset A. If no such link is found, the operations end at 814. However, if such links are found, for each such incoming or outgoing link to a web page of subset A, an operation 808 determines a location of such linked web page in subset A. An operation 810 adds such location of the linked web page from the subset A to a dictionary where the key is the location of the linked web page from the subset A and the value is the number of occurrences of this location for the web page in subset B. An operation 812 picks a common location from the dictionary and assigns it to the web page in subset B.

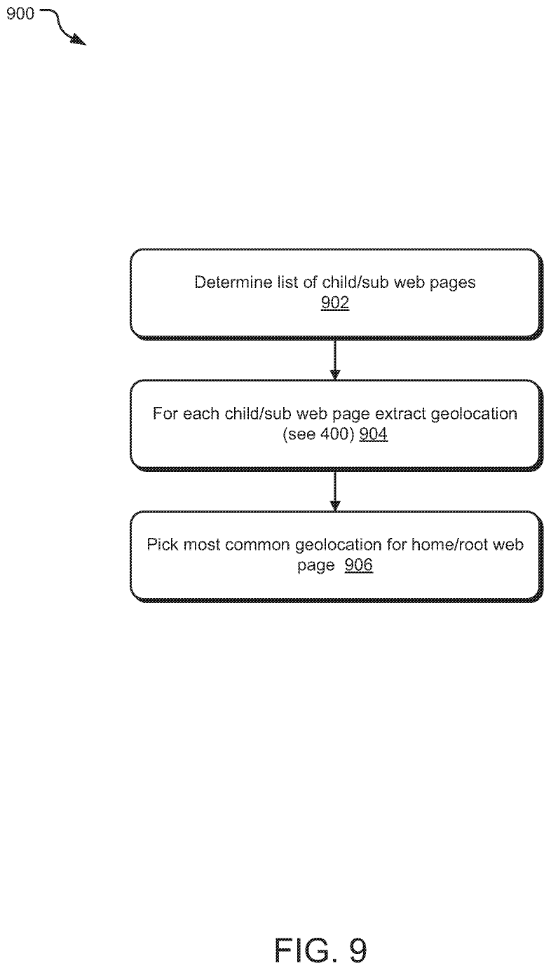

FIG. 9 illustrates operations 900 for assigning geolocations to web pages based on geolocations of child pages. The operation 900 assumes that for a particular website, the geolocations of several child (sub) pages are determined, but the geolocation of the root or home page of the website is unknown. This could be, for example, in a case where a child page may be linked to another web page with a known location, a child page may include an entity that may be used to identify the geolocation of the child page, etc. Note that for the operations 900, it is not required that the child pages link to the root of the home page, or vice versa.

An operation 902 determines a list of child or sub web pages for a web page. For each child or sub web page, an operation 904 extracts its geolocation information. An operation 906 picks a common geolocation from such geolocations of the child web pages and assigned it to the home or root web page.

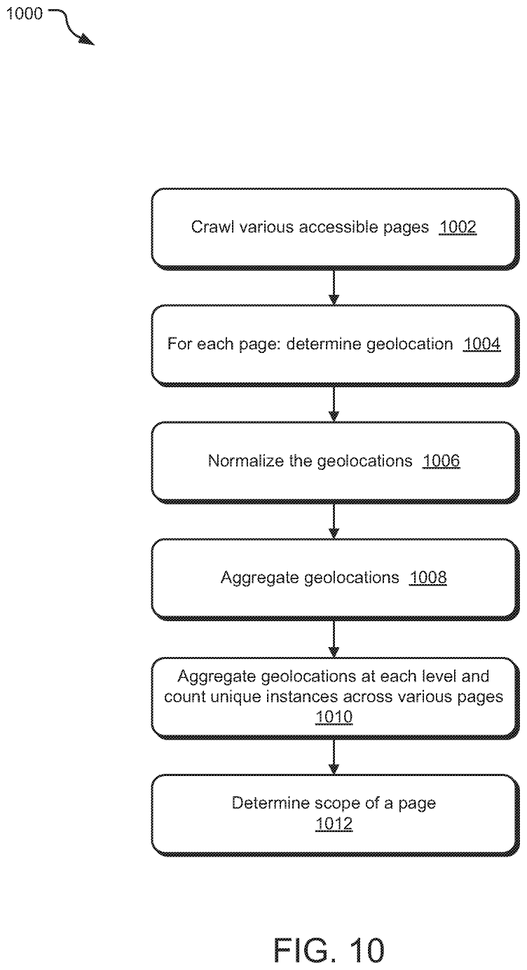

FIG. 10 illustrates operations 1000 for disambiguating between websites with local and global scope. There are many websites that contain references to a variety of locations throughout the world. For example, cnn.com contains thousands of articles that point to various locations. If the geolocation extraction and propagation system disclosed herein were to assign cnn.com the location most commonly mentioned in all its pages, it may be incorrect. To address this issue, an implementation disclosed herein provides a method for differentiating between local scope and global scope. Specifically, if a website does not mention any location, or it mentions a variety of locations across the world or the country, it is identified as having global scope. If a website mainly mentions a specific smaller geolocation, it has is identified as having a local scope.

An operation 1002 crawls all accessible pages of a website. For each page of the website, an operation 1004 determines if the web page mentions a geolocation, or can be assigned a geolocation using the one or more of the methods disclosed herein. An operation 1006 normalizes the geolocations for each of the web pages and an operation 1008 aggregates the various geolocations that can be assigned to the web pages. In one implementation, the operation 1008 aggregates the geolocations at different levels of granularity, such as aggregating count for individual countries, aggregating count for individual combination of countries and states, aggregating count for individual combinations of country, state, and city, etc. An operation 1010 aggregates the geolocations at each level of granularity and counts the unique instances across all pages of the website for various levels of granularities. For a given page, if the fraction of the count of a popular location over the count of all locations with that granularity is above a predetermined threshold, an operation 1012 determines that this page has a local scope. Otherwise, assume it has a global scope.

For example, for kirklandreporter.com, suppose that the location “Kirkland” is mentioned 800 times across all pages of kirklandreporter.com, the location “Seattle” is mentioned 300 times across all pages of kirklandreporter.com, and the location “Bellevue” is mentioned 200 times across all pages of kirklandreporter.com. In this case, “Kirkland” is obviously the popular location. The operation 1012 divides the count for “Kirkland” (800) over the count for all locations (800+300+200). The result is 0.615 (or about 62%). Given a predetermined threshold of 60%, the result of the division is above the predetermined threshold. Therefore, the operation 1012 determines that kirklandreporter.com has a local scope and the scope is “Kirkland, Wash.”. The operation 1012 may also be performed at other levels of granularity for the same page (for example “King County” or “Washington State”) to get even a higher threshold.

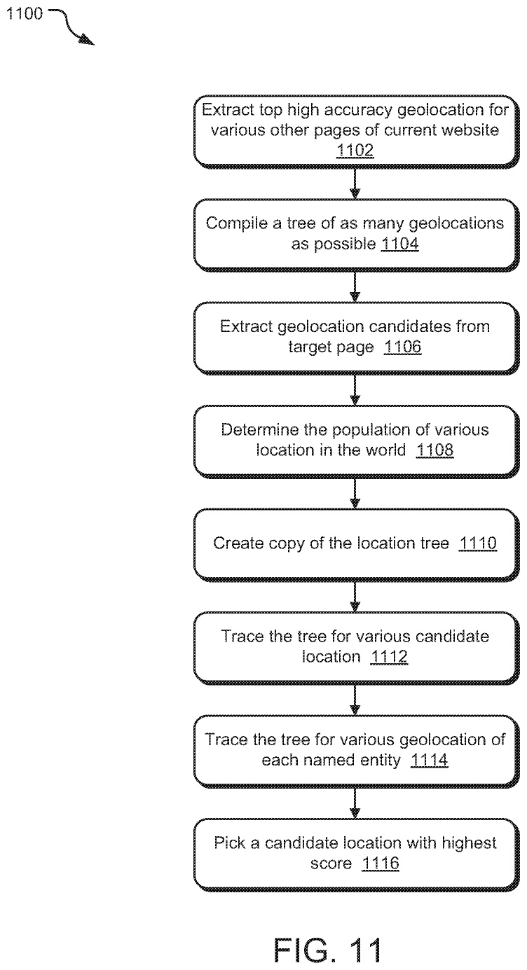

FIG. 11 illustrates operations 1100 for disambiguating between multiple candidate geolocations. Specifically, the operations 1100 address the issue of multiple geolocations having similar names. For example, there are at least ten (10) cities named “Easton” in the United States. Such ambiguous geolocation names make it difficult to correctly extract geolocations from text content of web pages. For example, if a news article mentions a geolocation named “Easton”, the geolocation extraction and propagation system disclosed herein disambiguates among the ten candidate cities named “Easton” in order to correctly geolocate the web page containing the news article. Specifically, the operations 1100 collects various pieces of information that may be used as disambiguation signals.

An operation 1102 extracts a top high accuracy geolocation from web pages of a website to which the disambiguation operations 1100 are applied. A high accuracy geolocation may be a geolocation that is specified with high specificity, such as “Easton, Pa.” In one implementation, the high accuracy geolocation candidates from a website may be extracted using a named entities extraction algorithm that may use a named entities database. A geolocation algorithm takes as input the extracted named entity locations and outputs a tuple where the first element is the precisely geolocated location such as “North America, United States of America, Pennsylvania, Northampton, Easton” and the second element is a confidence percentage score that represents how sure is the geolocation algorithm of the result.

The geolocation algorithm may ignore all results where the output confidence value is below a threshold, such as 80%, or where the result is ambiguous (more than one location candidate). Subsequently, the operation 1102 aggregates unique locations at different levels of granularity such as: count unique countries; count unique combinations of <country, state>; count unique combinations of <country, state, county>; and count unique combinations of <country, state, county, city>. A top location at each of these four levels of granularity is picked.

An operation 1104 compiles a tree of as many locations as possible. The operation 1104 may use a database that contains geographical entities and the relationships between them. As example, a good starting point would be the database made publicly available by geonames.org. Subsequently, the operation 1104 creates a tree of locations by starting from Earth, then finding all continents, then finding all countries in each continent, then finding each state or region in each country, etc. The operation 1104 may compile the tree bottom up by starting from all cities and going upward to counties, regions, countries, etc. In both cases, the result is a tree where the first level is a single item called Earth, then the second level contains all the continents, then the third level contains all the countries, etc.

An operation 1106 extracts geolocation candidates from a target page. In one implementation, the operation 1106 may extract potential geolocation candidates from a target web page using a named entities extraction algorithm. Subsequently, the operation 1106 uses a geolocation algorithm which takes as input the extracted named entity locations and outputs a tuple where the first element is the precisely geolocated location, such as “North America, United States of America, Pennsylvania, Northampton, Easton,” and the second element is a confidence percentage score that represents how sure is the geolocation algorithm of the result. Note that operation 1106 extracts a list of potential candidates for geolocations whereas the operation 1102 generates an output if there is a single geolocation candidate with high accuracy. For example, for the input “Easton,” the output of the operation 1106 may be a list of eleven tuples, one tuple for each city named “Easton” in “USA”. This list of tuples is the list of location candidates for the “Easton” named entity.

An operation 1108 determines the population of various locations in the world. Specifically, the operation 1108 uses the same data sources as used by the operation 1104 and compiles a list of all locations in the world along with their estimated populations.

An operation 1110 creates a copy of the tree generated at the operation 1104. For each candidate location of the named entity, an operation 1112 traces its path on the tree generated at the operation 1104. As the operation 1104 traces its path on the tree, it increments a counter attached to each node of the three that it touches. For instance, for the candidate location “North America, United States of America, Pennsylvania, Northampton, Easton”, the North America node counter would increment from 0 to 1, the “United States of America” node counter would increment from 0 to 1, etc. Note that if a subsequent candidate location is also in “PA, USA”, then both the “USA” counter and the “PA” counter would become two (2).

An operation 1114 traces the tree for each geolocation of various named entity extracted at operation 1102. The operation 1114 also increments the counters for the locations extracted at the operation 1102 by 2 (two). Such incrementing the counter effectively gives a higher weight for locations extracted during operation 1102 (high accuracy locations) compared to the locations extracted during the operation 1106 (ambiguous locations). An operation 1116 picks a candidate location from the various candidate locations generated at operation 1106. Specifically, the operation 1116 includes generating linear combination scores for each candidate location of the named entity, where the linear combination score takes into account the node counters of the candidate and of its parents and the distance in miles between the current candidate geolocation and all other geolocations with a different name traced on the tree in the above steps. If there is a tie, it can be resolved by boosting the score of the candidate with the highest population as determined at operation 1108.

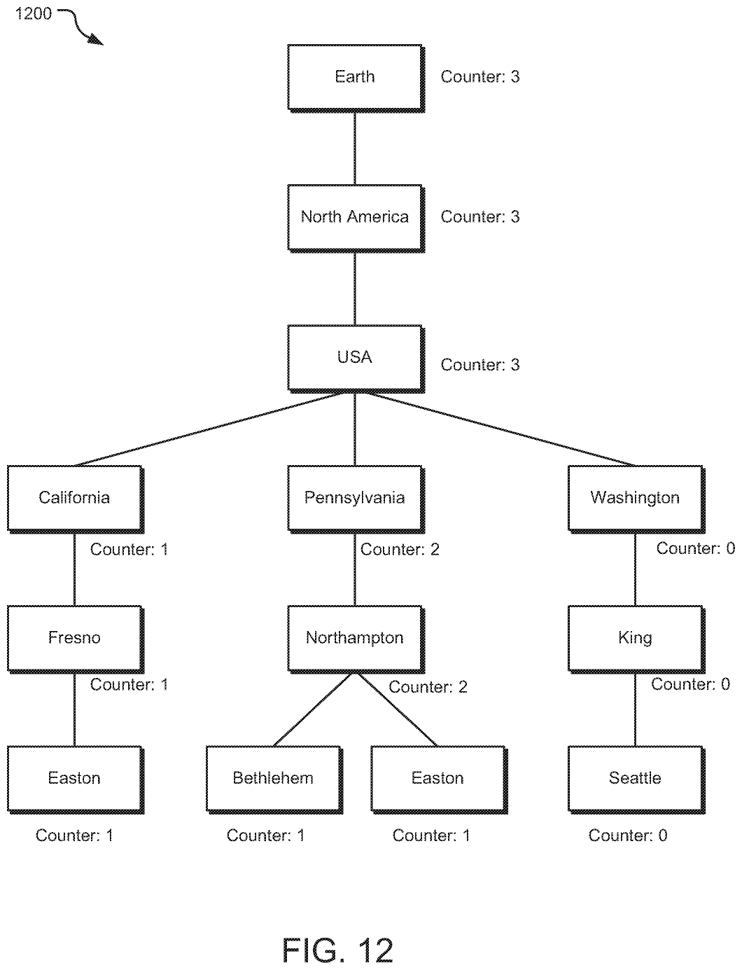

FIG. 12 illustrates a tree 1200 of locations used for disambiguating between multiple candidate geolocations as used by the operations 1100 as shown in FIG. 11. The tree 1200 may be illustrated in view of disambiguating geolocation of a website with a news article that contains the following text:

“A Bethlehem woman twice bit her boyfriend during an argument Tuesday night in an Easton apartment, city police say in court papers.”

The geolocation extraction and propagation system disclosed herein recognizes that the names “Bethlehem” and “Easton” in this article are ambiguous, because there are ten (10) cities named “Easton” in the US and five (5) cities named “Bethlehem.” The operation 1112 as shown in FIG. 11 traces the tree 1200 for each named entity Bethlehem and Easton to determine that out of all combinations of potential “Bethlehems” and “Eastons,” only two of them are located in the same county (Northampton, Pa.). This means that as the operation 1112 traces the candidate locations on the tree 1200, because two of these locations are in the same county, then the counter for their parent Northampton node gets incremented to two. Similarly, the operation 1116 as shown in FIG. 11 determines that out of all potential pairs of <Bethlehem, Easton> candidates, only two (2) of them are located close to each other (about 12 miles). Thus, the operations 1100 as shown in FIG. 11 determine that the correct geolocation of the website traces the tree from <Bethlehem, Easton> to Northampton, Pa., USA North America, World.

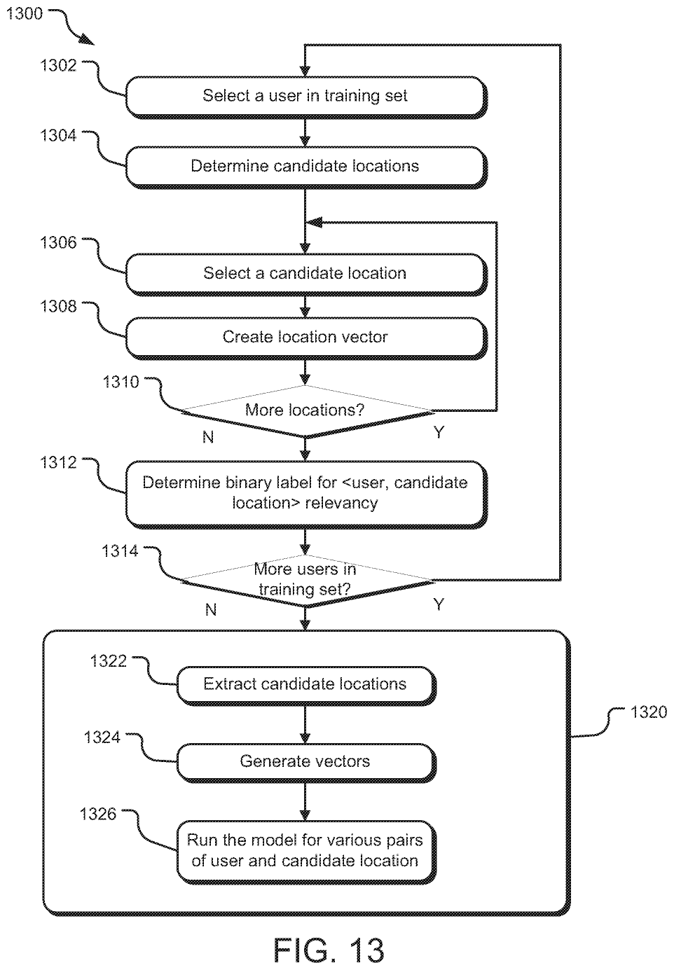

FIG. 13 illustrates operations 1300 for propagating locations based on user actions. Specifically, the operations 1300 disclose ranking the candidate locations assigned to different types of user actions and propagating the candidate locations to the user that performs the user actions.

A training phase, as illustrated by operations 1302 to 1314 builds a training model using a small subset of all possible users with known location of the users, where for a user and list of candidate locations the output is a list of tuples. The training phase of the operations 1300 use a log of user actions, a list of locations relevant to each user (ground truth used for training), and precomputed candidate locations for these actions using the methods described above in this document to train a model. Also, for the training model, the key is the candidate location and the value is a score between 0 and 1, which predicts the likelihood that this candidate location is relevant for this user or IP address.

An operation 1302 selects a user in the training set. For the selected user, an operation 1304 determines various candidate locations given as linked to the actions in the action log. An operation 1306 selects one of the various candidate locations. For the selected candidate location, an operation 1308 creates a location vector where each dimension of the location vector corresponds to a method used to determine this location and a corresponding value that represents a raw score of that method and that location. In one example, for a user A, multiple signals are found, where such signals point to Seattle as being a location candidate. Specifically, Seattle was extracted as a location for this user using multiple methods such as: the user sent ten (10) e-mails about Seattle, clicked on twenty (20) Seattle related websites, and has thirty (30) friends that live in Seattle. In this case, for the <User A, location Seattle> combination the operation 1308 generates a vector with three (3) dimensions as below, one for each method where Seattle was extracted as a location for this user:

E-mail dimension, value: 10

Website click dimension, value: 20

Friends dimension, value: 30

An operation 1310 evaluates whether there are more such locations extracted and repeats the operations 1306 and 1308 for each such additional location, resulting in one or more candidate location vectors. An operation 1312 determines a binary label for each <user, candidate location> where a value of 1 for the binary label means the candidate location is relevant and a value of 0 for the binary label means that the candidate location value is irrelevant. In one implementation, such binary value is generated by building a logical regression model that tunes the weights used for each dimension of the vector. An operation 1314 evaluates if the operations of extracting candidate locations, generating location vectors, and determining relevancy are to be repeated for more users.

Subsequently, the trained model is applied on new data, as illustrated by operations 1320. The operations 1320 use a log of user actions for users where the locations relevant to the user are unknown and precomputed candidate locations for these actions to find locations of new users. The operations 1320 may be performed per user of various users. Specifically, for a given new user, an operation 1322 extracts distinct candidate locations relevant to the given new user. An operation 1324 generates vectors in a manner discussed above in operation 1308. Subsequently, for a pair of users and a candidate location, an operation 1326 applies the trained model generated by the operations 1302-1324 to determine if a candidate location is relevant for a given new user. Thus, in effect, the trained model allows locations to propagate from entities such as web pages to users without locations though user actions, such as clicks.

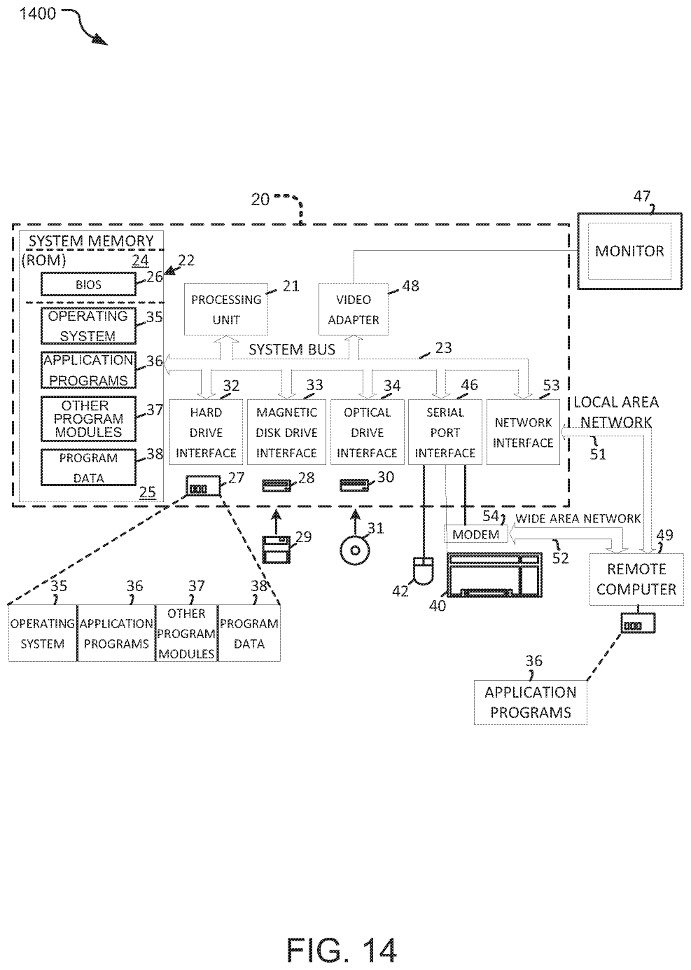

FIG. 14 illustrates an example system 1400 that may be useful in implementing the described technology for geolocation extraction and propagation. The example hardware and operating environment of FIG. 14 for implementing the described technology includes a computing device, such as a general purpose computing device in the form of a computer 20, a mobile telephone, a personal data assistant (PDA), a tablet, smart watch, gaming remote, or other type of computing device. In the implementation of FIG. 14, for example, the computer 20 includes a processing unit 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units 21, commonly referred to as a parallel processing environment. The computer 20 may be a conventional computer, a distributed computer, or any other type of computer; the implementations are not so limited. An implementation of the computer 20 may be used to implement the system for extracting and propagating geolocation information as disclosed herein.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk drive 27, magnetic disk 29, optical disk 31, ROM 24, or RAM 25, including an operating system 35, one or more application programs 36, other program modules 37, and program data 38. For example, one or more modules of the geolocation extraction and propagation system disclosed herein may be implemented with instructions on the hard disk drive 27, magnetic disk 29, optical disk 31, ROM 24, or RAM 25. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor 47, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 14 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are examples and other means of communications devices for establishing a communications link between the computers may be used.

In an example implementation, software or firmware instructions for extracting and propagating geolocations may be stored in memory 22 and/or storage devices 29 or 31 and processed by the processing unit 21. Rules for extracting and propagating geolocations may be stored in memory 22 and/or storage devices 29 or 31 as persistent datastores. For example, a geolocation extraction module may be implemented with instructions stored in the memory 22 and/or storage devices 29 or 31 and processed by the processing unit 21. Similarly, one or more modules of a geolocation determination and propagation system may also be implemented with instructions stored in the memory 22 and/or storage devices 29 or 31 and processed by the processing unit 21. The memory 22 may be used to store one or more geolocation extraction and propagation modules.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The system for geolocation extraction and propagation may include a variety of tangible computer-readable storage media and intangible computer-readable communication signals. Tangible computer-readable storage can be embodied by any available media that can be accessed by the geolocation determination and extraction system 120 (FIG. 1) and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the geolocation determination and extraction system 120 (FIG. 1). In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

A system for determining geolocation of a user comprises a memory, one or more processor units, and a geolocation extraction module stored in the memory and executed by the one or more processor units, the geolocation extraction module configured to assign a geolocation to a web page based on content of the web page and geolocations assigned to a plurality of users, wherein each of the plurality of users is associated with the web page, and assign the geolocation of the web page to a new user when the new user clicks on the web page. In one implementation of the system, each of the plurality of users is associated with the web page by at least one of having viewed the web page, having searched for the web page, and having clicked on the content of the web page. In an alternative implementation of the system, the geolocation extraction module is further configured to assign a geolocation to a web page based on content of the web page by converting the content of the web page to plain text and extracting from the plain text one or more strings representing geolocations.

In another implementation of the system, a child page geolocation allocation module configured to analyze content of a child page related to the web page to determine one or more strings representing geolocations, determine child page geolocation based on the one or more strings representing geolocations, and allocate the child page geolocation to the web page. In yet another implementation of the system, a web links analysis module configured to analyze incoming and outgoing links from the web page to determine the geolocation of the web page. In another implementation of the system, a user click analysis module stored in the memory and executable by the one or more processor units, the user click analysis module configured to determine the location of the web page based on locations of one or more users clicking on the web page.

In an alternative implementation of the system, a user query analysis module stored in the memory and executable by the one or more processor units, the user query analysis module configured to determine the location of the web page based on locations of users submitting queries that result in a click on the web page.

A method of assigning a geolocation to a new user comprises assigning a geolocation to a web page based on content of the web page and geolocations assigned to a plurality of users, wherein each of the plurality of users is associated with the web page and assigning the geolocation of the web page to the new user when the new user clicks on the web page. In one implementation of the method, each of the plurality of users is associated with the web page by at least one of having viewed the web page, having searched for the web page, and having clicked on the content of the web page. In yet another implementation of the method, assigning the geolocation to the web page based on content of the web page further includes converting the content of the web page to plain text and extracting from the plain text one or more strings representing geolocations. An alternative implementation of the method further comprises validating and normalizing the one or more strings representing geolocations; and if the validation is successful, increasing the granularity of the geolocation to a desired level.

In one implementation, the method also includes adding the normalized granular geolocation to a dictionary, wherein the dictionary includes the normalized granular geolocation as a key and number of occurrences of the normalized granular geolocation on the web page as a value. In another implementation, assigning the geolocation to the web page based on the content of the web page further includes analyzing content of a child page related to the web page to determine one or more strings representing geolocations, determining child page geolocation based on the one or more strings representing geolocations, and allocating the child page geolocation to the web page.

In one implementation, assigning the geolocation to the web page based on the content of the web page further comprises analyzing content of a linked page linked to the web page to determine one or more strings representing geolocations, determining linked page geolocation based on the one or more strings representing geolocations and allocating the linked page geolocation to the web page. In one implementation, assigning the geolocation to the web page based on geolocations assigned to the plurality of users further comprises assigning geolocations to users based on inferring location of one of the plurality of users based on at least one of an online profile of the one of the plurality of users and a geographical positioning system (GPS) trace of the user. In another implementation, if it is determined that one or more strings of the web page content is related to more than one geolocations, disambiguating between the more than one geolocations by using a tree of locations related to the more than one geolocations.

A physical article of manufacture including one or more tangible computer-readable storage media, encoding computer-executable instructions for executing on a computer system a computer process, the computer process comprising assigning a geolocation to a web page based on content of the web page and geolocations assigned to a plurality of users, wherein each of the plurality of users is associated with the web page and assigning the geolocation of the web page to a new user when the new user clicks on the web page. In an alternative implementation, the computer process further comprises converting the content of the web page to plain text and extracting from the plain text one or more strings representing geolocations. In yet another implementation, the computer process further comprising validating and normalizing the one or more strings representing geolocations and if the validation is successful, increasing the granularity of the geolocation to a desired level. In one implementation, the computer process further comprising adding the normalized granular geolocation to a dictionary, wherein the dictionary includes the normalized granular geolocation as a key and number of occurrences of the normalized granular geolocation on the web page as a value.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A system for determining geolocation of a user, comprising:
memory;
one or more processor units;
a geolocation extraction module stored in the memory and executed by the one or processor units, the geolocation extraction module configured to:
assign a geolocation to a web page based on content of the web page and geolocations assigned to a plurality of users, wherein each of the plurality of users is associated with the web page, and
assign the geolocation of the web page to a new user in response to the new user's click on the web page.

2. The system of claim 1, wherein each of the plurality of users is associated with the web page by at least one of having viewed the web page, having searched for the web page, and having clicked on the content of the web page.

3. The system of claim 2, wherein the geolocation extraction module is further configured to assign a geolocation to a web page based on content of the web page by converting the content of the web page to plain text and extracting from the plain text one or more strings representing geolocations.

4. The system of claim 3, further comprising a child page geolocation allocation module configured to analyze content of a child page related to the web page to determine one or more strings representing geolocations, determine child page geolocation based on the one or more strings representing geolocations, and allocate the child page geolocation to the web page.

5. The system of claim 3, further comprising a web links analysis module configured to analyze incoming and outgoing links from the web page to determine the geolocation of the web page.

6. The system of claim 3, further comprising a user click analysis module stored in the memory and executable by the one or more processor units, the user click analysis module configured to determine the location of the web page based on locations of one or more users clicking on the web page.

7. The system of claim 3, further comprising a user query analysis module stored in the memory and executable by the one or more processor units, the user query analysis module configured to determine the location of the web page based on locations of users submitting queries that result in a click on the web page.

8. A method of assigning a geolocation to a new user, the method comprising:
assigning a geolocation to a web page based on content of the web page and geolocations assigned to a plurality of users, wherein each of the plurality of users is associated with the web page; and
assigning the geolocation of the web page to the new user in response to the new user's click on the web page.

9. The method of claim 8, wherein each of the plurality of users is associated with the web page by at least one of having viewed the web page, having searched for the web page, and having clicked on the content of the web page.

10. The method of claim 8, wherein assigning e geolocation to the web page based on content of the web page further comprising:
converting the content of the web page to plain text; and
extracting from the plain text one or more strings representing geolocations.

11. The method of claim 10, further comprising:
validating and normalizing the one or more strings representing geolocations; and
if the validation is successful, increasing the granularity of the geolocation to a desired level.

12. The method of claim 11, further comprising adding the normalized granular geolocation to a dictionary, wherein the dictionary includes the normalized granular geolocation as a key and number of occurrences of the normalized granular geolocation on the web page as a value.

13. The method of claim 8, wherein assigning the geolocation to the web page based on the content of the web page further comprising:
analyzing content of a child page related to the web page to determine one or more strings representing geolocations;
determining child page geolocation based on the one or more strings representing geolocations; and
allocating the child page geolocation to the web page.

14. The method of claim 8, wherein assigning the geolocation to the web page based on the content of the web page further comprising:
analyzing content of a linked page linked to the web page to determine one or more strings representing geolocations;
determining linked page geolocation based on the one or more strings representing geolocations; and
allocating the linked page geolocation to the web page.

15. The method of claim 8, wherein assigning the geolocation to the web page based on geolocations assigned to the plurality of users further comprises assigning geolocations to users based on inferring location of one of the plurality of users based on at least one of an online profile of the one of the plurality of users and a geographical positioning system (GPS) trace of the user.

16. The method of claim 8, further comprising:
if it is determined that one or more strings of the web page content is related to more than one geolocations, disambiguating between the more than one geolocations by using a tree of locations related to the more than one geolocations.

17. A physical article of manufacture including one or more tangible computer-readable storage media, encoding computer-executable instructions for executing on a computer system a computer process, the computer process comprising:
assigning a geolocation to a web page based on content of the web page and geolocations assigned to a plurality of users, wherein each of the plurality of users is associated with the web page; and
assigning the geolocation of the web page to a new user in response to the new user's click on the web page.

18. The physical article of manufacture of claim 17, wherein the computer process further comprising converting the content of the web page to plain text and extracting from the plain text one or more strings representing geolocations.

19. The physical article of manufacture of claim 18, wherein the computer process further comprising validating and normalizing the one or more strings representing geolocations and if the validation is successful, increasing the granularity of the geolocation to a desired level.

20. The physical article of manufacture of claim 19, wherein the computer process further comprising adding the normalized granular geolocation to a dictionary, wherein the dictionary includes the normalized granular geolocation as a key and number of occurrences of the normalized granular geolocation on the web page as a value.
